(19) United States
(12) Patent Application Publication
(10) Pub. No.: US 2002/0100626 A1
(43) Pub. Date: Aug. 1, 2002

(54) Structure of front end module and method of assembling same

(76) Inventors: Chang-Young Kang, Kunpo-City (KR); Hee-Seouk Chung, Hwasung-City (KR)

Correspondence Address: Pennie & Edmonds, LLP, 3300 Hillview Avenue, Palo Alto, CA, 94304, US

(21) Appl. No.: 10/028,116

(22) Filed: Dec. 20, 2001

(30) Foreign Application Priority Data
Dec. 26, 2000 (KR) 2000-81616

(51) Int. Cl. B60K 11/04

(52) U.S. Cl. 180/68.4

(57) ABSTRACT

A structure of a front end module is disclosed to include horn module, cooling module, bumper and head lamps assembled at one panel and then mounted onto a front side member of a vehicle body at a single work step in a vehicle assembly line, thereby enabling a reduction in the number of assembly processes and in the relevant manufacturing cost.

### BACKGROUND OF THE INVENTION

The present invention relates to a front end module, and more particularly to a structure of a front end module including front end panel, horn module, cooling module, bumper and head lamps that can be assembled onto a vehicle body in a single work step.

In general, a vehicle is composed of vehicle body and chassis. The vehicle body includes an interior, an engine compartment, a trunk room, and a fender and the like for constructing an external shape of the vehicle and providing a driver and passengers with elements such as safety, space, residence and the like. Generally, chassis is the term for parts of the vehicle other that the vehicle body. The chassis includes compartments and units necessary for a running the vehicle on a frame.

The frame is preferably light and durable, strong enough to stand against bend, twist, tension and vibration caused by impact of a rough road or a load of heavy cargo while a vehicle is running.

However, at present, for medium and small passenger vehicles, an integrally assembled structure of a frame and vehicle body has been used to make the vehicle lighter, to protect vehicle riders and to reduce an impact against other vehicles through effective absorption during a vehicle crash. In such an integral structure, a frame is not separately manufactured, but compartments, power train, running units and the like are attached to one vehicle body that has a particular strength. Therefore, it becomes possible to reduce weight of a vehicle and secure its greater effective space.

In the integral structure of a vehicle as such, the front end module forming a front part of a vehicle is manufactured in a subassembly with all parts of the module supplied by subcontractors and then assembled in the assembly line of a vehicle manufacturer.

FIGS. 1 and 2 illustrate a conventional front end module, including cooling module 1 and horn module 2 of a separately installed T-shaped support panel 3, U-shaped support panel 5 at a front side member 7 of a vehicle body 6 and head lamps 4 at both sides of the U-shaped support panel 5. After completion of all modules, the T-shaped support panel 3 having the cooling and horn modules 1, 2 is mounted on the U-shaped support panel 5 of the front side member 7. Then, the front end module is completely mounted on the vehicle body 6.

However, there is a problem in the prior art in that there is a need for separate assembly lines such as a line for assembling the cooling and horn modules 1, 2 at the T-shaped support panel 3 and the other for assembling the head lamps 4 and completely assembled T-shaped support panel 3 to the U-shaped support panel 5 when the front end module is assembled at the front side member of the vehicle body, thereby resulting in a problem of an increase in the relevant manufacturing cost.

### SUMMARY OF THE INVENTION

It is an object of the present invention to solve the aforementioned problems and make a reduction in production cost through a cutback of assembling processes by completely assembling all parts of a front end module at one panel and then mounting it onto a vehicle body.

In order to accomplish the aforementioned object of the present invention, there is provided a structure of a front end module constructed with all parts assembled on a front end panel and then mounted onto it with horn module, cooling module, bumper and head lamps at one work step.

According to an embodiment of the invention a front end panel is provided at a work step in an assembly line and a horn module, a cooling module, a bumper and head lamps are mounted on the front end panel to form a front end module. Thereafter, the front end module is secured to the vehicle body. In a preferred embodiment the front end module is bolted to the vehicle body.

In a preferred embodiment the front end panel is provided in a unitary structure having upper and lower horizontal cross members joined by two outer vertical members and a central vertical member, with said upper cross member having outward extending portions extending beyond said outer vertical members. Further, in one preferred embodiment the horn module is mounted on the central vertical member, the cooling module is mounted on the horizontal cross members and outer vertical members on a first side of the front end panel, the bumper is attached to the outer vertical members on a second side of the front end panel opposite the cooling module, and the headlamp is mounted on each upper cross member outward extending portion. Preferably the outward extending portions further extend back from the front panel in the direction of the cooling module.

### BRIEF DESCRIPTION OF THE DRAWINGS

Objects and aspects of the invention will become apparent from the following description of preferred embodiments with reference to the accompanying drawings in which:

FIG. 1 is a perspective view illustrating a part of parts constructing a conventional front end module;

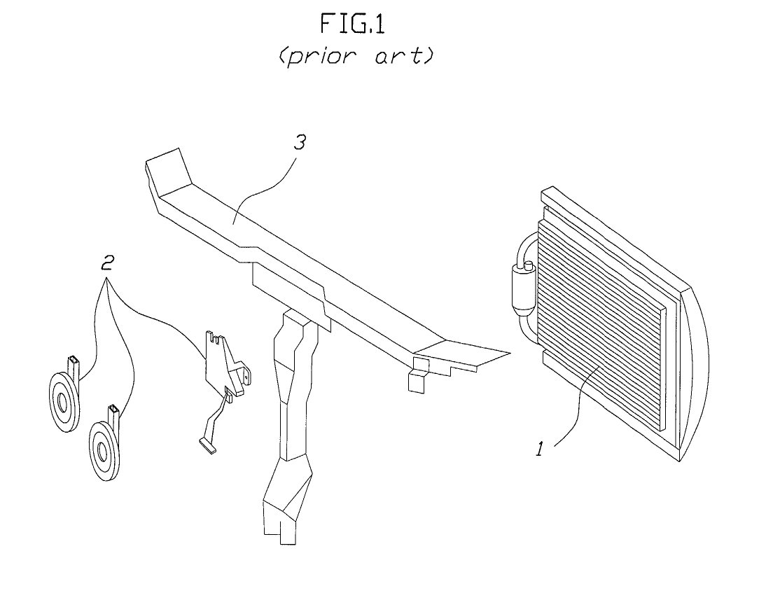

FIG. 2 is a perspective view illustrating mounting the module shown in FIG. 1 onto a vehicle body;

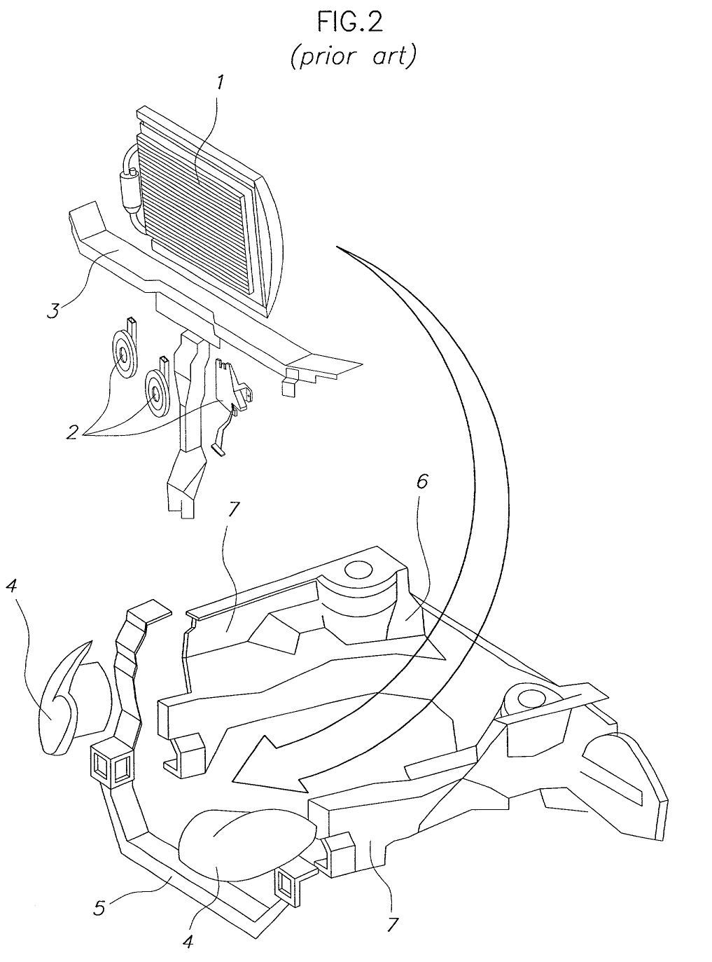

FIG. 3 is an exploded view illustrating an embodiment of the present invention;

FIG. 4 is a perspective view illustrating an embodiment of the present invention; and

FIG. 5 is a perspective view illustrating mounting the module shown in FIG. 4 onto a vehicle body.

### DETAILED DESCRIPTION OF THE INVENTION

Hereinafter, a preferred embodiment of the present invention will be described in detail with reference to accompanying drawings.

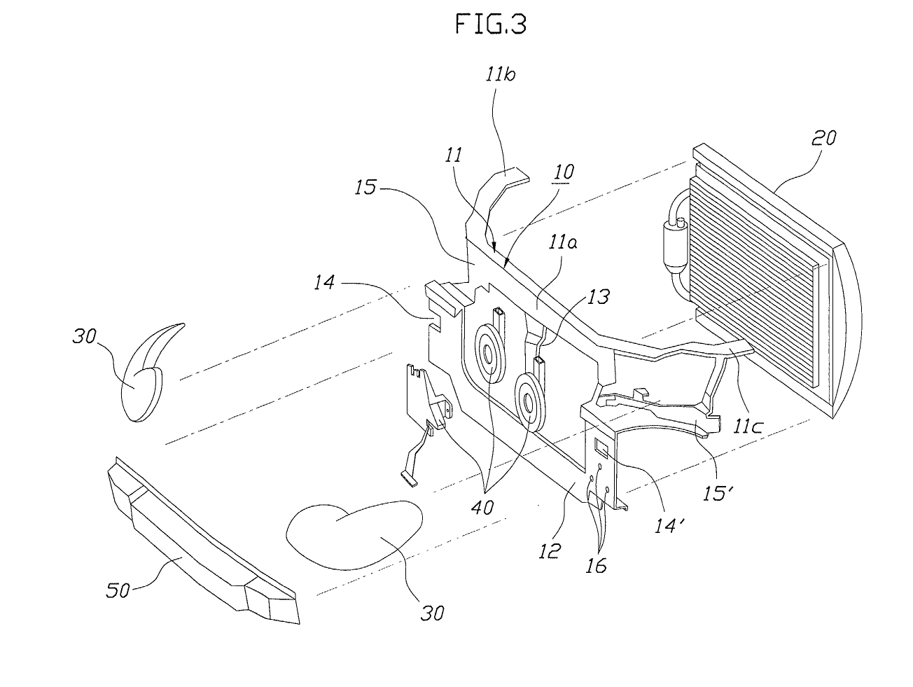

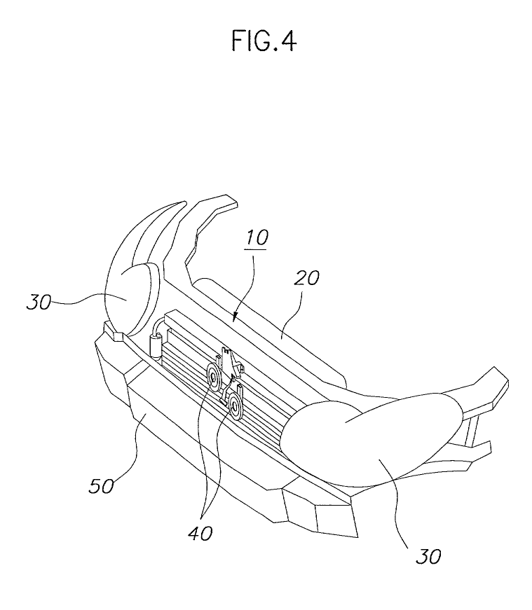

FIGS. 3 and 4 are drawings for illustrating an embodiment of the present invention. As shown in the drawings, a front end panel 10 includes: a radiator support upper member 11 having center, left and right members 11a, 11b, 11c; a radiator support center member 13 perpendicularly connected to the radiator support upper member 11; a radiator support lower member 12 horizontally connected to the bottom of the radiator support center member 13; a radiator support left and right members 14, 14′ perpendicularly connected to the left and right ends of the radiator support lower member 12 with their top being connected with the radiator support upper member 11; and head lamp support panels 15, 15′ connected with the radiator support left and right members 14, 14′ and left and right members 11b, 11c.

The front end panel of the present invention is constructed as follows: a horn module 40 is mounted onto the radiator support center member 13 and a cooling module 20 is mounted at a peripheral surface consisting of center member 11a of the radiator support upper member 11, radiator support lower member 12 and radiator support left and right members 14, 14′. Furthermore, a bumper 50 is attached onto the bottom of the radiator support left and right members 14, 14′, and head lamps 30 are mounted at a peripheral surface consisting of left and right members 11b, 11c and head lamp support panels 15, 15′. As a result, the front end module is completed as shown in FIG. 4.

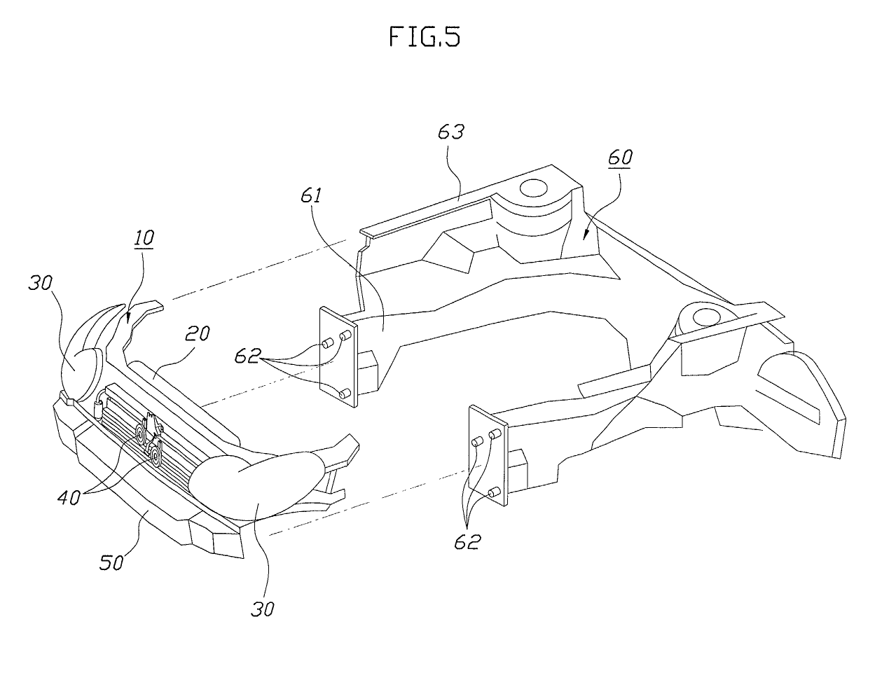

As described above, the front end module with parts mounted on the front end panel 10 is, as shown in FIG. 5, completely assembled to a vehicle body by fastening bolts 62 formed at a front side member 61, through fastening holes 16, formed at the bottom of the radiator support left and right members 14, 14′, with nuts, and by fastening or welding the end of the left and right members 11b, 11c to the fender 63 of the vehicle body 60.

In other words, the front end module is completed by getting all necessary parts supplied by sub-contractors and assembled in a vehicle assembly line at a single work step.

As described above, there is an advantage in the front end module of the present invention in that cooling module, head lamps, bumper and horn modules are assembled at one panel and then mounted onto the front side member of the vehicle body at a single work step in one vehicle assembly line, thereby making a reduction in the number of assembly processes and in the relevant production cost.

what is claimed is:

1. A structure of a front end module including a front end panel, the front end panel comprising:
a radiator support upper member having center, left and right members;
a radiator support center member perpendicularly connected to the radiator support upper member;
a radiator support lower member horizontally connected to the bottom of the radiator support center member opposite said upper member;
radiator support left and right members perpendicularly connected to left and right ends of the radiator support lower member, each having a top connected to the radiator support upper member; and
head lamp support panels connected to a radiator support left and right members, wherein a horn module, a cooling module, a bumper and head lamps are integrally mounted on the front end panel.

2. The structure, as defined in claim 1, wherein fastening holes are formed at the
bottom of the radiator support left and right members to be fastened with bolts
onto the front side member of the vehicle body.

3. A method of assembling a front end of a vehicle body in a single work step in a vehicle assembly line, comprising:
providing a front end panel at the work step;
mounting a horn module, a cooling module, a bumper and head lamps on said front end panel to form a front end module; and
securing said front end module to a vehicle body.

4. The method according to claim 3, wherein said securing the front end module comprises bolting the front end module to the vehicle body.

5. The method according to claim 3, wherein said front end panel comprises upper and lower horizontal cross members joined by two outer vertical members and a central vertical member, with said upper cross member having outward extending portions extending beyond said outer vertical members.

6. The method according to claim 5, wherein said mounting comprises:
mounting the horn module on the central vertical member;
mounting the cooling module to said horizontal cross members and outer vertical members on a first side of said front end panel;
attaching said bumper to said outer vertical members on a second side of the front end panel opposite said cooling module; and
mounting a headlamp on each said upper cross member outward extending portion.

7. A front end module for a vehicle, comprising a front end panel in a unitary structure having upper and lower horizontal cross members joined by two outer vertical members and a central vertical member, with said upper cross member having outward extending portions extending beyond said outer vertical members.

8. The front end module according to claim 7, further comprising:
a horn module mounted on the central vertical member;
a cooling module mounted on said horizontal cross members and outer vertical members on a first side of said front end panel;
a bumper attached to said outer vertical members on a second side of the front end panel opposite said cooling module; and
a headlamp mounted on each said upper cross member outward extending portion.

9. The front end module according to claim 8, wherein said outward extending portions further extend back from the front panel in the direction of the cooling module.
